(19) United States
(12) Patent Application Publication
(10) Pub. No.: US 2024/0394431 A1
(43) Pub. Date: Nov. 28, 2024

(54) A CONFIDENCE-AWARE SERVICE PATTERN OPTIMIZATION METHOD

(71) Applicant: ZHEJIANG UNIVERSITY, Hangzhou, ZHEJIANG PROVINCE (CN)

(72) Inventors: MENG XI, HANGZHOU, ZHEJIANG PROVINCE (CN); JIANWEI YIN, HANGZHOU, ZHEJIANG PROVINCE (CN); SHUIGUANG DENG, HANGZHOU, ZHEJIANG PROVINCE (CN); YING LI, HANGZHOU, ZHEJIANG PROVINCE (CN)

(21) Appl. No.: 18/273,015

(22) PCT Filed: Jul. 18, 2022
(86) PCT No.: PCT/CN2022/106250

§ 371 Date: Jul. 18, 2023

(30) Foreign Application Priority Data
Apr. 18, 2022 (CN) 202210401977.9

(51) Int. Cl. G06F 30/20; G06F 111/06; G06F 119/08

(52) U.S. Cl. CPC G06F 30/20; G06F 2111/06; G06F 2119/08

(57) ABSTRACT

Disclosed in the present invention is a confidence-aware service pattern optimization method, wherein the service pattern optimization method comprises the following steps: (1) inputting an original pattern Pa to be optimized; (2) initializing a candidate list PaList of the original pattern Pa; (3) initializing a temperature T; (4) initializing confidence C; (5) initializing a maximum number of iterations IterMax; (6) initializing a termination threshold Th; (7) circularly searching a target pattern Pa* according to pattern optimization indexes, wherein the number of circulations is IterMax; (8) reducing the temperature T; (9) if the pattern Pa* obtained at the end of the cycle in step (7) remains consistent for consecutive Th times, obtaining the Pa* as an optimized target pattern; otherwise, jumping to step (7). By introducing the confidence mechanism, the search speed and search step size can be dynamically adjusted in the search space with different optimization potentials, which greatly saves the optimization time and improves the optimization effect.

### FIELD OF TECHNOLOGY

The present invention belongs to the field of service pattern calculation in software engineering, and in particular to a confidence-aware service pattern optimization method.

### BACKGROUND TECHNOLOGY

In contrast to traditional web services, current complex service systems typically consist of autonomous entities (called participants) from different domains and cloud services on different servers. In these complex service systems, the participants can refer to virtual users or intelligent agents that need to collaborate and interact with other entities to continue a service process. During the collaboration, an overall paradigm used to describe the process, in which data, resources, and value are transferred and exchanged among the participants, is called a service pattern.

The service pattern refers to the collaboration among different participants and the exchange of data, resources and value in the complex service system. The service pattern originates from an extension to a workflow and a traffic process. To support analysis of the complex service system, the service pattern complements a traditional service modeling method by describing the traffic from four aspects: the workflow, a data flow, a resource flow, and a value flow.

For example, the Chinese patent literature with the public number CN111612330A discloses a quantitative evaluation method of a service pattern for a cross-border service: defining top-level elements of the service pattern, comprising defining participants, a workflow, a data flow, a resource flow and a cash flow; describing participants in the service pattern; describing the workflow among the participants based on existing participants; describing the data flow among the participants based on the workflow among the participants; describing the resource flow among the participants based on the workflow among the participants; describing the cash flow among the participants based on the workflow among the participants; calculating evaluation indexes, including running time, consumption cost, delivery efficiency, value and reliability, of the service pattern based on the described workflow, data flow, resource flow and cash flow; and calculating pattern entropy according to the evaluation indexes so as to evaluate the service pattern as a whole. This method can help product managers, entrepreneurs, business consultants, and business designers to quantitatively evaluate existing service patterns.

An important concern of service pattern analysis is service pattern optimization, which plays a crucial role in iteration of the complex service system. Previous studies have done a lot of work on service process optimization, but due to limitation of service model description ability, influence of a service deployment platform on service pattern performance has been ignored.

In addition, there are also a study which consider resource capacity and infrastructure cost and proposes a cloud service distribution problem (CSDP) to optimize coordination of cloud services in a cloud network environment. However, a comprehensive analysis of the collaboration among the participants is still missing.

In order to solve these problems, a goal of the service pattern optimization is not only to improve the quality of service (QOS), but also to pay attention to the efficiency of data, resources and value transfer and rationality of an overall arrangement of the service pattern. Therefore, it is urgent to design a new service pattern optimization method to solve the above problems existing in the prior art.

### SUMMARY OF THE INVENTION

The present invention provides a confidence-aware service pattern optimization method, which can greatly save optimization time and improve optimization effect.

A confidence-aware service pattern optimization method, wherein the service pattern optimization method comprises the following steps:

(1) inputting an original pattern Pa to be optimized, wherein the original pattern Pa consists of a plurality of participants and a workflow, a data flow, a resource flow and a value flow among the participants;

(2) initializing a candidate list PaList of the original pattern Pa;

(3) initializing a temperature T;

(4) initializing confidence C;

(5) initializing a maximum number of iterations IterMax;

(6) initializing a termination threshold Th;

(7) circularly searching a target pattern Pa* according to pattern optimization indexes, wherein the number of circulations is IterMax;

(8) reducing the temperature T; and

(9) if the pattern Pa* obtained at the end of the cycle in step (7) remains consistent for consecutive Th times, obtaining the Pa* as an optimized target pattern; otherwise, jumping to step (7).

In step (2), the candidate list PaList initializes four copies of the Pa.

In step (3), a calculating formula of the initialization temperature T is as follows: T=K*X²;

wherein K is set as a real number between 5 and 10, and X² is a variance of an optimization index sequence formed by the original pattern Pa and a pattern generated after a random search of the original pattern Pa.

In step (4), the confidence C is any real number; when the confidence C is negative, it means that optimization potential of a current evolution direction is weak; when the confidence C is positive, it means that the optimization potential of the current evolution direction is strong; and an initial value of the confidence C is 0.

In step (5), initializing a maximum number of iterations IterMax as follows;

$$Iter Max = ( \vert Activity \vert / ( \vert Event \vert + \vert Gateway \vert ) ) ! * ( \vert Event \vert + \vert Gateway \vert )$$

wherein |Activity|, |Event| and |Gateway| are respectively the number of activities, number of events, the number of gateways contained in the optimized pattern, and ! represents the factorial.

In step (6), an initial value of the termination threshold Th is rounded up from log(IterMax).

In step (7), the pattern optimization indexes include 6 individual indexes and 1 overall index, wherein the 6 individual indexes are pattern running time Ti, pattern running cost Co, pattern entropy En, data transfer efficiency DaEf, resource transfer efficiency ReEf, and value transfer efficiency VaEf; and the overall index is pattern loss, and the formula is as follows:

$$Lo = ( log ( Ti ) + log ( Co ) ) \times 3 En / ( DaEf + ReEf + VaEf )$$

wherein the pattern running time Ti, pattern running cost Co, pattern entropy En and pattern loss Lo are the smaller the better; and the data transfer efficiency DaEf, resource transfer efficiency ReEf and value transfer efficiency VaEf are the larger the better.

In step (7), when the target pattern Pa* is circularly searched, steps of each search are as follows:

(7-1) setting a search step size St, wherein if C is greater than or equal to 0, St is 1, and if C is less than 0, St is the smaller one in 1-C and |Activity|/2;

(7-2) performing activity execution sequence exchange for St times for the optimization pattern Pa to be optimized to obtain Pa^{f};

(7-3) performing activity execution platform exchange for St times for the optimization pattern Pa to be optimized to obtain Pa^{d};

(7-4) performing the transformation occurred in step (7-2) and step (7-3) for the optimization pattern Pa to be optimized to obtain Pa^{h} simultaneously;

(7-5) letting the pattern candidate list PaList=[Pa, Pa^{f}, Pa^{d}, Pa^{h}];

(7-6) comparing individual indexes of pattern optimization in a pattern candidate list of the last iteration and a pattern candidate list of this round one by one; if the pattern index of this round is better, increasing the confidence C by 1; and if the pattern index of this round is worse, decreasing the confidence C by 1;

(7-7) if the value of confidence C is unchanged or larger after step (7-6), adopting the pattern candidate list generated in this round; otherwise, adopting the pattern candidate list generated in the last round of iteration as PaList; and

(7-8) comparing the optimization indexes of four patterns in PaList, if an optimal pattern of the optimization indexes is one of Pa^{f}, Pa^{d} and Pa^{h}, adopting this pattern as the pattern Pa to be optimized to enter a next iteration; and if the optimal pattern of the optimization indexes is Pa, adopting, according to a probability of e^{DIFF/T}, an optimal pattern of Pa^{f}, Pa^{d} and Pa^{h} as the pattern Pa to be optimized to enter the next iteration;

wherein DIFF=−|an optimization index value of Pa−an average optimization index value of Pa^{f}, Pa^{d}, Pa^{h}|, otherwise remaining Pa as the pattern to be optimized.

In step (8), the method of reducing the temperature T is as follows:

$$T = T / log ( 1 + IterT + reg ( C ) )$$

wherein IterT is the number of times the temperature T has decreased, reg(C)=(e^{C}−1)/(e^{C}+1).

Compared with the prior art, the present invention has the following beneficial effects:

1. The present invention can optimize the overall service pattern through traffic logic optimization and service distribution optimization, and improve the final optimization effect compared with the traditional method that only optimizes traffic logic or service distribution.

2. The present invention can take into account the transmission efficiency of data, resources and value in the service pattern while optimizing the time, cost and entropy of the pattern through the overall index pattern loss.

3. By introducing the confidence mechanism, the search speed and search step size can be dynamically adjusted in the search space with different optimization potentials, which greatly saves the optimization time and improves the optimization effect.

### BRIEF DESCRIPTION OF THE DRAWINGS

FIG. 1 is a schematic diagram of a confidence-aware service pattern optimization method in the present invention;

FIG. 2 is a schematic diagram of an initial service pattern imported in the embodiment of the present invention; and

FIG. 3 is a schematic diagram of a service pattern optimized by the optimization method in the embodiment of the present invention.

### DETAILED DESCRIPTION OF THE EMBODIMENTS

The present invention will be further described in detail below with reference to the accompanying drawings and embodiments. It should be pointed out that the following embodiments are intended to facilitate the understanding of the present invention, but do not have any limiting effect on it.

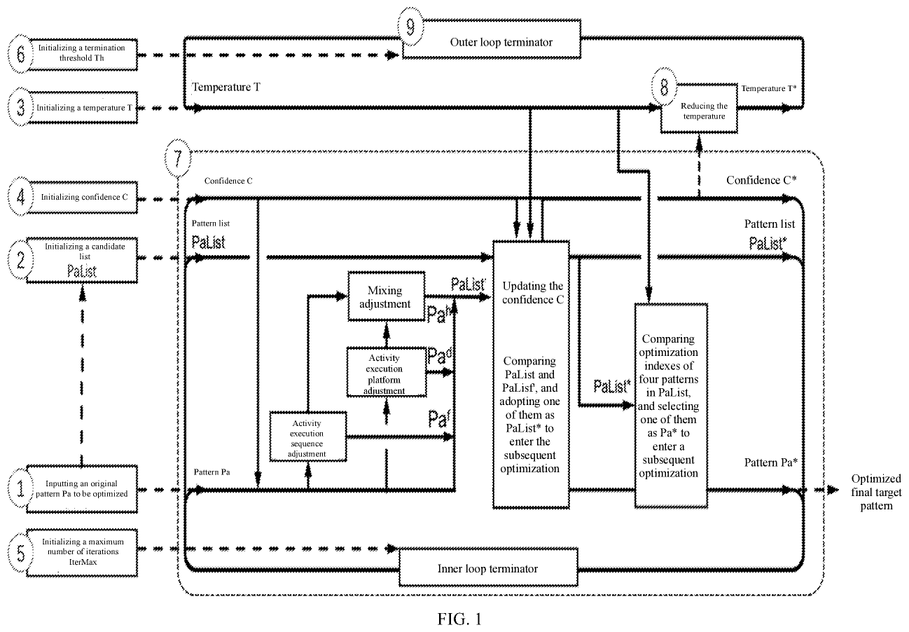

As shown in FIG. 1, a confidence-aware service pattern optimization method comprises the following steps:

Step (1), inputting an original pattern Pa to be optimized.

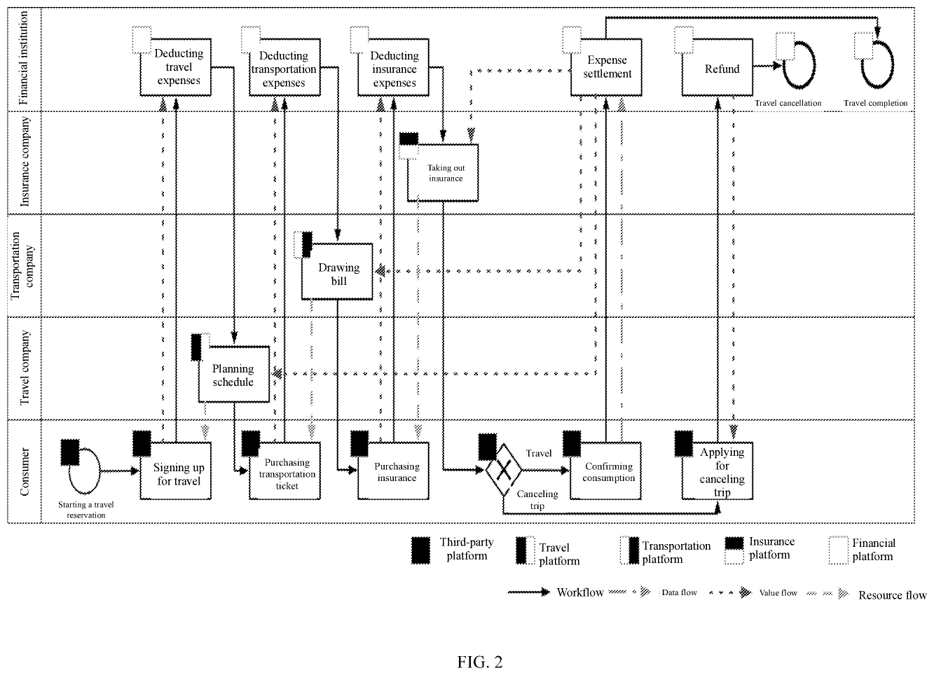

This embodiment takes an online travel booking pattern as an example. As shown in FIG. 2, a customer applies for travel sign-up, purchases a transportation ticket and applies for insurance in turn. Between each two operations, the customer pays a financial institution, and then a travel platform, a transport company and an insurance company confirm a request and transfer out a travel voucher, a transport bill and an insurance proof. After all these activities, the customer has an opportunity to notify the financial institution to cancel the entire travel application, otherwise the financial institution settles the value of the customer's payment with all stakeholders.

The disadvantage of the original pattern is that after almost each activity ends, the work needs to be handed over to another participant and a next activity needs to be completed on a different server, resulting in a lot of extra time and cost.

Step (2), initializing a candidate list PaList as four copies of the original pattern Pa.

Step (3), by sampling the optimization overall index Lo of the original pattern Pa several times, initializing a temperature T=0.8346.

Step (4), initializing confidence C=0.

Step (5), initializing a maximum number of iterations IterMax=(13/(3+1))!*(3+1)=33.14, which is taken as 34.

Step (6), initializing a termination threshold Th=log(34)=3.5264, which is taken as 4.

Step (7), circularly searching a target pattern Pa* according to pattern optimization indexes, wherein this step is circularly performed for IterMax=34 times.

(7-1) since C−0, setting a search step size as St=1;

(7-2) performing activity execution sequence exchange for St=1 time for the optimization pattern Pa to be optimized to obtain Pa^{f};

(7-3) performing activity execution platform exchange for St=1 time for the optimization pattern Pa to be optimized to obtain Pa^{d};

(7-4) performing the transformation occurred in (7-2) and (7-3) for the optimization pattern Pa to be optimized to obtain Pa^{h} simultaneously;

(7-5) letting the pattern list PaList=[Pa, Pa^{f}, Pa^{d}, Pa^{h}];

(7-6) comparing individual indexes of pattern optimization in a pattern list of the last iteration [Pa, Pa, Pa, Pa] and a pattern list of this round [Pa, Pa^{f}, Pa^{d}, Pa^{h}] one by one. For example, in this round, performance of Pa is {Ti:1502.33, Co:313.44, En:1.4729, DaEf:12.56, ReEf:3.99, VaEf:12.00}, performance of Pa^{f} is {Ti:1483.60, Co:364.30, En:1.5292, DaEf:13.44, ReEf:2.61, VaEf:11.71}, performance of Pa^{d} is {Ti:1295.66, Co:280.15, En:1.4544, DaEf:16.42, ReEf:3.70, VaEf:11.85}, performance of Pa^{h} is {Ti:1293.51, Co:262.57, En:1.4977, DaEf:16.68, ReEf:4.90, VaEf:10.94}. First, first items in the lists of this round iteration and the last iteration are compared, and because they are the same, so the confidence C is unchanged; then, second items in the lists of this round iteration and the last iteration are compared, and Ti and DaEf of this round are better, so the confidence value is increased by 2, and Co, En, ReEf and VaEf of this round are worse, the confidence C is decreased by 4, so confidence C=0+2−4=−2; third items in the lists of this round iteration and the last iteration are compared, and Ti, Co, En and DaEf of this round are better, so the confidence value is increased by 4, while ReEf and VaEf of this round are worse, so the confidence C is decreased by 2, which results the confidence C=−2+4−2−0; and fourth items in the lists of this round iteration and the last iteration are compared, Ti, Co, DaEf and ReEf of this round are better, so the confidence value is increased by 4, while En and VaEf of this round are worse, so the confidence C is decreased by 2, which results in the confidence C=0+4−2−2;

(7-7) if the value of confidence C becomes larger after (7-6), adopting the pattern list PaList=[Pa, Pa^{f}, Pa^{d}, Pa^{h}] which is generated in this round;

(7-8) comparing the optimization indexes of the four patterns in PaList, wherein the indexes are 2.0212, 2.1816, 1.7480, and 1.7599, respectively; if the pattern Pa^{d} with the optimal optimization index is Pa^{d}, adopting this pattern as the mode Pa to be optimized to enter the next iteration.

Step (8), since it is the first time to reduce the temperature, IterT=1, and confidence C=47 step (7), reducing the temperature to after the cyclic search in T=0.8346/(1+1+(e⁴⁷−1)/(e⁴⁷+1))=0.2782.

Step (9) if the pattern Pa* obtained at the end of the cycle in step (7) remains consistent for consecutive Th=4 times, obtaining Pa* as a found optimization target pattern.

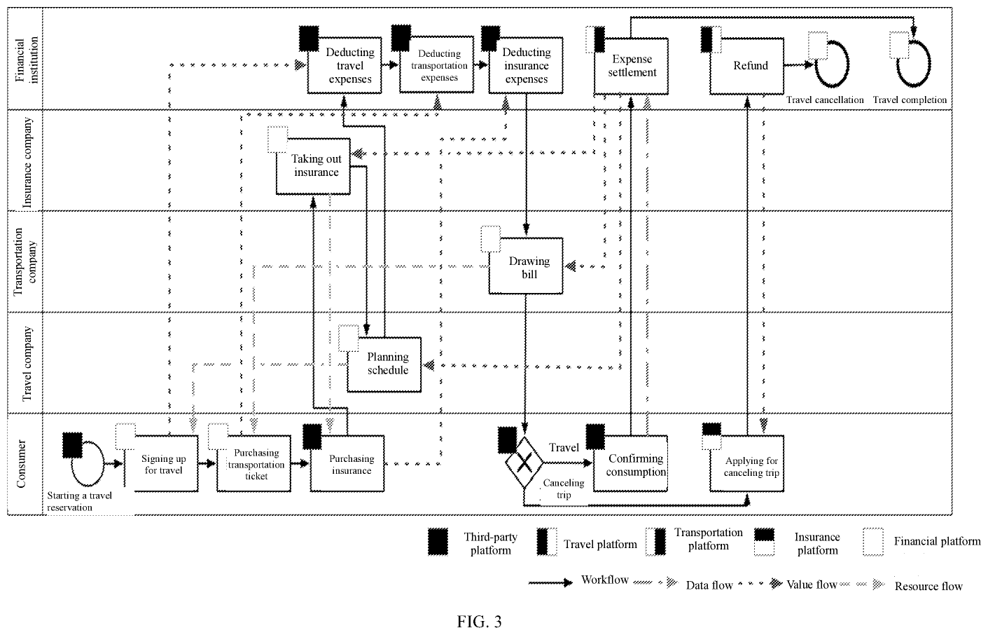

FIG. 3 shows an optimization target pattern from an experiment. It is clear that the traffic logic and service distribution are optimized. The traffic logic becomes that the customer does all the ordering first and then the four service providers do everything else, which greatly reduces the time of collaboration among the participants. In addition, more adjacent activities are performed on the same server, thus reducing costs. Furthermore, in the process of algorithm optimization, the transmission efficiency of data, resources and value and the overall performance are also taken into account. A final performance of the optimization target pattern is Lo=1.6296, Ti=1173.36, Co=197.69, En=1.4347, DaEf=16.83, ReEf=4.34, VaEf=11.48. It can be seen that the optimized service pattern performs better on Lo, Ti, Co, En, DaEf and ReEf.

In addition, the method of the present invention is compared with three traditional methods, namely, the existing simulated annealing method, the method of service distribution optimization only, and the method of traffic logic optimization only.

Each method carries out 1000 optimization experiments, and finally average values are taken for comparison. The results are shown in Table 1.

TABLE 1

| | | | An existing | | |
|---|---|---|---|---|---|
| | | The method in | simulated | Only service | Only traffic |
| | | the present | annealing | distribution | logic |
| | Origin | invention | algorithm | optimization | optimization |
| Lo | 1.9827 | 1.6395 | 1.7147 | 1.7336 | 1.902 |
| Ti | 1483.2105 | 1383.8663 | 1437.4936 | 1527.4145 | 1401.4036 |
| Co | 355.5755 | 208.4038 | 245.2512 | 217.4287 | 346.1472 |
| En | 1.4721 | 1.4700 | 1.4577 | 1.4719 | 1.4770 |
| DaEf | 13.3085 | 16.9046 | 16.7526 | 16.8891 | 15.2538 |
| ReEf | 3.9915 | 5.8166 | 5.533 | 3.4428 | 5.5031 |
| VaEf | 12.0605 | 11.0615 | 10.2503 | 12.0336 | 9.7598 |
| Average number of | / | 63.5446 | 68.7426 | 65.8812 | 63.6634 |
| iterative search | | | | | |
| rounds required | | | | | |

It can be seen that the method of the present invention performs better than other methods on the comprehensive index Lo, and the average number of iterative search rounds required is the least.

The above embodiments provide a detailed description of the technical solution and beneficial effects of the present invention. It should be understood that the above embodiments are only specific embodiments of the present invention and are not used to limit the present invention. Any modification, supplement and equivalent substitution made within the scope of the principles of the present invention shall be included in the protection scope of the present invention.

1. A confidence-aware service pattern optimization method, wherein the service pattern optimization method comprises the following steps:
(1) inputting an original pattern Pa to be optimized, wherein the original pattern Pa consists of a plurality of participants and a workflow, a data flow, a resource flow and a value flow among the participants;
(2) initializing a candidate list PaList of the original pattern Pa;
(3) initializing a temperature T;
(4) initializing confidence C;
(5) initializing a maximum number of iterations IterMax;
(6) initializing a termination threshold Th;
(7) circularly searching a target pattern Pa* according to pattern optimization indexes, wherein the number of circulations is IterMax;
(8) reducing the temperature T; and
(9) if the pattern Pa* obtained at the end of the cycle in step (7) remains consistent for consecutive Th times, obtaining the Pa* as an optimized target pattern; otherwise. jumping to step (7).

2. The confidence-aware service pattern optimization method according to claim 1, wherein in step (2), the candidate list PaList initializes four copies of the Pa.

3. The confidence-aware service pattern optimization method according to claim 1, wherein in step (3), a calculating formula of the initialization temperature T is as follows: T=KX²;
wherein K is set as a real number between 5 and 10, and X² is a variance of an optimization index sequence formed by the original pattern Pa and a pattern generated after a random search of the original pattern Pa.

4. The confidence-aware service pattern optimization method according to claim 1, wherein in step (4), the confidence C is any real number; when the confidence C is negative, it means that optimization potential of a current evolution direction is weak; when the confidence C is positive, it means that the optimization potential of the current evolution direction is strong; and an initial value of the confidence C is 0.

5. The confidence-aware service pattern optimization method according to claim 1, wherein in step (5), a formula for initializing the maximum number of iterations IterMax is as follows:
$$Iter Max = ( \vert Activity \vert / ( \vert Event \vert + \vert Gateway \vert ) ) ! \times ( \vert Event \vert + \vert Gateway \vert )$$
wherein |Activity|, |Event| and |Gateway| are respectively the number of activities, number of events, the number of gateways contained in the optimized pattern, and ! represents the factorial.

6. The confidence-aware service pattern optimization method according to claim 1, wherein in step (6), an initial value of the termination threshold Th is rounded up from log(IterMax).

7. The confidence-aware service pattern optimization method according to claim 1, wherein in step (7), the pattern optimization indexes includes 6 individual indexes and 1 overall index, wherein the 6 individual indexes are pattern running time Ti, pattern running cost Co, pattern entropy En, data transfer efficiency DaEf, resource transfer efficiency ReEf, and value transfer efficiency VaEf; and the overall index is pattern loss, and the formula is as follows:
$$Lo = ( log ( Ti ) + log ( Co ) ) \times 3 En / ( DaEf + ReEf + VaEf )$$
wherein the pattern running time Ti, pattern running cost Co, pattern entropy En and pattern loss Lo are the smaller the better; and the data transfer efficiency DaEf, resource transfer efficiency ReEf and value transfer efficiency VaEf are the larger the better.

8. The confidence-aware service pattern optimization method according to claim 1, wherein in step (7), when the target pattern Pa* is circularly searched, steps of each search are as follows:
(7-1) setting a search step size St, wherein if C is greater than or equal to 0, St is 1, and if C is less than 0, St is the smaller one in 1-C and | Activity|/2;
(7-2) performing activity execution sequence exchange for St times for the optimization pattern Pa to be optimized to obtain Pa^{f};
(7-3) performing activity execution platform exchange for St times for the optimization pattern Pa to be optimized to obtain Pa^{d};
(7-4) performing the transformation occurred in step (7-2) and step (7-3) for the optimization pattern Pa to be optimized to obtain Pa^{h} simultaneously;
(7-5) letting the pattern candidate list PaList= [Pa, Pa^{f}, Pa^{d}, Pa^{h}];
(7-6) comparing individual indexes of pattern optimization in a pattern candidate list of the last iteration and a pattern candidate list of this round one by one; if the pattern index of this round is better, increasing the confidence C by 1; and if the pattern index of this round is worse, decreasing the confidence C by 1;
(7-7) if the value of confidence C is unchanged or larger after step (7-6), adopting the pattern candidate list generated in this round; otherwise, adopting the pattern candidate list generated in the last round of iteration as PaList; and
(7-8) comparing the optimization indexes of four patterns in PaList, if an optimal pattern of the optimization indexes is one of Pa^{f}, Pa^{d} and Pa^{h}, adopting this pattern as the pattern Pa to be optimized to enter a next iteration; and if the optimal pattern of the optimization indexes is Pa, adopting, according to a probability of e^{DIFF/T}, an optimal pattern of Pa^{f}, Pa^{d} and Pa^{h} as the pattern Pa to be optimized to enter the next iteration;
wherein DIFF=−|an optimization index value of Pa−an average optimization index value of Pa^{f}, Pa^{d}, Pa^{h}|, otherwise remaining Pa as the pattern to be optimized.

9. The confidence-aware service pattern optimization method according to claim 1, wherein in step (8), the method of reducing the temperature T is as follows:
T=T/log(1+IterT+reg(C))
wherein IterT is the number of times the temperature T has decreased, reg(C)=(e^{C}−1)/(e^{C}+1).
